(19) United States
(12) Patent Application Publication
(10) Pub. No.: US 2017/0295524 A1
(43) Pub. Date: Oct. 12, 2017

(54) APPARATUSES AND METHODS FOR INDICATION OF FULL CONFIGURATION IN HANDOVER SIGNALING

(71) Applicant: Nokia Technologies Oy, Espoo (FI)

(72) Inventors: Esa Mikael MALKAMAKI, Espoo (FI); Henri Markus KOSKINEN, Espoo (FI); Tero HENTTONEN, Espoo (FI); Sean KELLEY, Hoffman Estates, IL (US); Anders Jan Olof KALL, Esbo (FI)

(21) Appl. No.: 15/468,640

(22) Filed: Mar. 24, 2017

Related U.S. Application Data
(60) Provisional application No. 62/320,083, filed on Apr. 8, 2016.

(51) Int. Cl. H04W 36/00; H04L 12/801; H04W 36/08

(52) U.S. Cl. CPC H04W 36/0061; H04W 36/08; H04L 47/34; H04W 36/0072

(57) ABSTRACT

Systems, methods, apparatuses, and computer program products for the indication of full configuration in handover signaling are provided. For example, an indication of “full configuration” and/or “no full configuration” may be included in handover signaling over X2 and/or S1 interface to a source eNB.

### RELATED APPLICATION

This application claims priority to Provisional Application 62/320,083, filed Apr. 8, 2016.

### BACKGROUND

### Field

Embodiments of the invention generally relate to wireless communications networks, such as, but not limited to, the Universal Mobile Telecommunications System (UMTS) Terrestrial Radio Access Network (UTRAN), Long Term Evolution (LTE) Evolved UTRAN (E-UTRAN), LTE-Advanced (LTE-A), and/or 5G radio access technology. In particular, some embodiments may relate to handover signaling and/or data forwarding for such networks.

### Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN), no RNC exists and radio access functionality is provided by an evolved Node B (eNodeB or eNB) or many eNBs. Multiple eNBs are involved for a single UE connection, for example, in case of Coordinated Multipoint Transmission (CoMP) and in dual connectivity.

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least, for example, 75 megabits per second (Mbps) per carrier and downlink peak rates of at least, for example, 300 Mbps per carrier. LTE supports scalable carrier bandwidths from 20 MHz down to 1.4 MHz and supports both Frequency Division Duplexing (FDD) and Time Division Duplexing (TDD).

As mentioned above, LTE may also improve spectral efficiency in networks, allowing carriers to provide more data and voice services over a given bandwidth. Therefore, LTE is designed to fulfill the needs for high-speed data and media transport in addition to high-capacity voice support. Advantages of LTE include, for example, high throughput, low latency, FDD and TDD support in the same platform, an improved end-user experience, and a simple architecture resulting in low operating costs.

Certain releases of 3GPP LTE (e.g., LTE Rel-10, LTE Rel-11, LTE Rel-12, LTE Rel-13) are targeted towards international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A is a more optimized radio system fulfilling the international telecommunication union-radio (ITU-R) requirements for IMT-Advanced while maintaining backward compatibility. One of the key features of LTE-A, introduced in LTE Rel-10, is carrier aggregation, which allows for increasing the data rates through aggregation of two or more LTE carriers.

5^{th} generation wireless systems (5G) refers to the new generation of radio systems and network architecture. 5G is expected to provide higher bitrates and coverage than the current LTE systems. Some estimate that 5G will provide bitrates one hundred times higher than LTE offers. 5G is also expected to increase network expandability up to hundreds of thousands of connections. The signal technology of 5G is anticipated to be improved for greater coverage as well as spectral and signaling efficiency.

### BRIEF DESCRIPTION OF THE DRAWINGS

For proper understanding of the invention, reference should be made to the accompanying drawings, wherein:

FIG. 1a illustrates an example block diagram of a message, according to one embodiment;

FIG. 1b illustrates an example block diagram of a message, according to another embodiment;

FIG. 2a illustrates an example signaling diagram, according to one embodiment;

FIG. 2b illustrates an example signaling diagram, according to another embodiment;

FIG. 3 illustrates a block diagram of a system, according to an embodiment;

FIG. 4 illustrates a block diagram of a system, according to another embodiment;

FIG. 5a illustrates a block diagram of an apparatus, according to one embodiment;

FIG. 5b illustrates a block diagram of an apparatus, according to one embodiment;

FIG. 6a illustrates an example flow diagram of a method, according to an embodiment;

FIG. 6b illustrates an example flow diagram of a method, according to another embodiment;

FIG. 6c illustrates an example flow diagram of a method, according to another embodiment; and

FIG. 6d illustrates an example flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for the indication of full configuration in handover signaling, as represented in the attached figures, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

As part of the 3GPP Rel-13 work item entitled, “LTE Carrier Aggregation Enhancement Beyond 5 Carriers” (eCA), the Packet Data Convergence Protocol (PDCP) Sequence Number (SN) field length was extended to 18 bits to accommodate increased peak data rates. In order to support 18 bits PDCP SN length during handover with downlink (DL) data forwarding, a new type of general packet radio service (GPRS) Tunnelling Protocol (GTP) user plane (GTP-U) extension header “Long PDCP PDU Number” was added to 3GPP technical specification (TS) 29.281. The contents of 3GPP TS 29.281, as well as 3GPP TS 36.413 v.13.2.0, 3GPP TS 36.423 v.13.3.0, and 3GPP TS 36.331 v.13.0.0, are hereby incorporated by reference in their entirety.

A problem arises in handover when a source eNB uses PDCP PDU format that the target eNB does not support. As one example, this may occur when the source eNB uses 18 bits PDCP SN length and the target eNB does not support the 18 bits PDCP SN length. If a target eNB that does not support the new GTP-U extension header would receive a GTP protocol data unit (G-PDU) with 18 bits PDCP protocol data unit (PDU) number, the target eNB discards the corresponding G-PDU. In addition, the target eNB shall, as specified in 3GPP TS 29.281, log an error and send a Supported Extension Headers Notification to the peer GTP-U entity.

However, when indirect data forwarding is used and a Serving Gateway (SGW) 230 is serving as an intermediate GTP-U entity, the target eNB will send the Supported Extension Header Notification message to the SGW 230, but per existing specification, the SGW will not forward this Support Extension Header Notification message to the source eNB. As a result, the source eNB will continue forwarding PDCP Service Data Units (SDUs) with 18 bits PDCP SN to this target eNB during this and subsequent handovers. This leads to continuous errors being logged and Supported Extension Header Notification messages being sent to the SGW. Forwarding of PDCP SDUs with PDCP SNs is unnecessary in this case as the target eNB shall discard these since the handover in this case requires a full configuration (due to UE configuration that the target eNB cannot fully support).

More generally, when full configuration is used in handover, the forwarding of PDCP SDUs (which have been allocated PDCP SN from a source eNB) to a target eNB is unnecessary and inefficient since the target eNB is supposed to discard these PDCP SDUs. The problem arises since the source eNB does not know that a full configuration of the UE radio resource control (RRC) connection is being done. This is because the handover command with the new UE RRC configuration is sent from the target eNB to the source eNB in a transparent container that the source eNB is not reading.

Certain embodiments of the invention introduce an indication of ‘full configuration’ and/or ‘no full configuration’ into handover signaling, for example over X2 and/or S1 interface, from a target eNB to a source eNB. This indication of ‘full configuration’ and/or ‘no full configuration’ allows the source eNB to, for instance, skip data forwarding of the packets that would be discarded anyway.

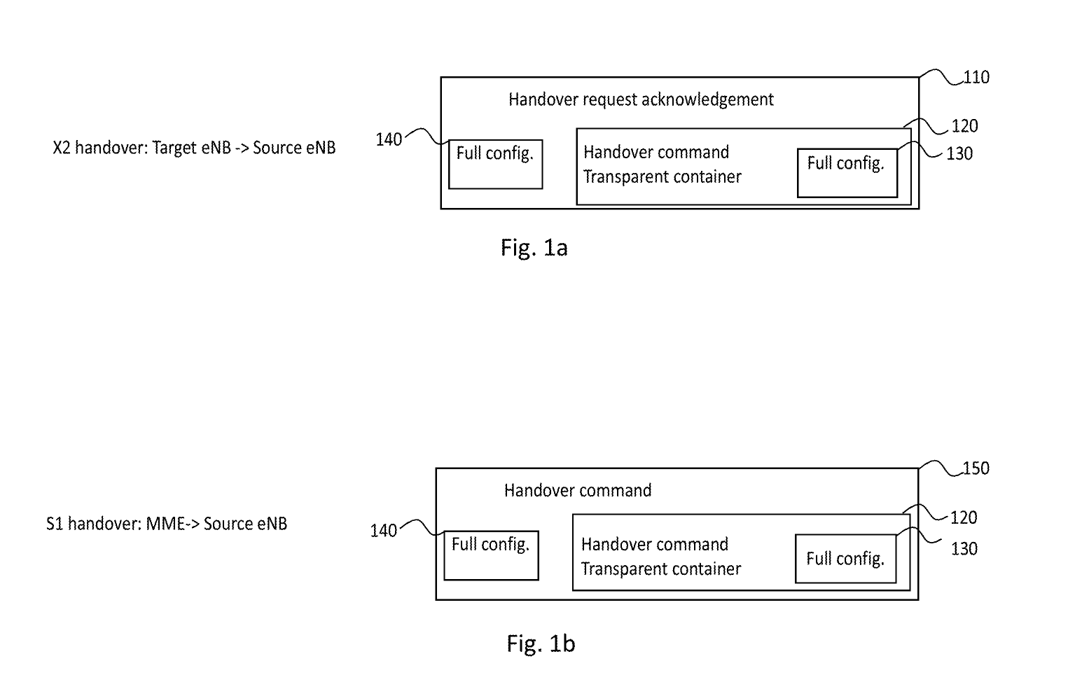

FIG. 1a illustrates an example embodiment where, in case of X2 handover, the indication 140 of whether ‘full configuration’ or ‘no full configuration’ is used may be included in a Handover Request Acknowledge message 110 sent from a target eNB to a source eNB (the same message contains the Target eNB To Source eNB Transparent Container 120 which includes the RRC E-UTRA Handover Command message 130 as defined in subclause 10.2.2 in 3GPP TS 36.331). In certain embodiments, the indication 140 of whether ‘full configuration’ or ‘no full configuration’ is used may be included twice in separate parts of the Handover Request Acknowledge message 110, such as once in a transparent container destined for the UE associated with the handover and once in a non-transparent container destined for the source eNB associated with the handover. In another embodiment, the indication 140 of whether ‘no full configuration’ is used may be included in the Handover Request Acknowledgement message 110 outside the transparent container such that the source eNB can read it.

FIG. 1b illustrates an example embodiment where, in case of S1 handover, the indication 140 may be included in the Handover Request Acknowledge message sent from the target eNB to the mobility management entity (MME), and in the Handover Command message 150 sent from the MME to the source eNB. In an embodiment, the indication 140 may be carried in a container that is transparent to the MME but not transparent to the source eNB. By contrast, the handover command transparent container 120 is transparent to both the source eNB and the MME. In another embodiment, the indication 140 may be carried in a container that is not transparent to either the MME or the source eNB.

In one embodiment, the indication 140 may be a Full Configuration Indicator information element (IE). If the Handover Command message 150 contains the Full Configuration Indicator IE, it indicates whether the target eNB will handle forwarded downlink data according to the target eNB procedures for full configuration handover as specified in 3GPP TS 36.300.

In one embodiment, the indication 140 may be a No Full Configuration Indicator information element (IE). If the Handover Command message 150 or Handover Request Acknowledgement message 110 contains the No Full Configuration Indicator IE, it indicates whether the target eNB will handle forwarded downlink data according to the target eNB procedures for full configuration handover or not as specified in 3GPP TS 36.300. In particular, if No Full Configuration Indicator IE is not present, then the source eNB knows that full configuration is being used and source eNB would not forward PDCP SDUs with PDCP SNs.

In some embodiment, the indication 140 of ‘full configuration’ or ‘no full configuration’ informs the source eNB of whether the target eNB will handle forwarded downlink data according to the target eNB procedures for full configuration handover as specified in 3GPP TS 36.300, which provides: “The target eNB may not send PDCP SDUs for which delivery was attempted by the source eNB. The target eNB identifies these by the presence of the PDCP SN in the forwarded GTP-U packet and discards them.” According to one embodiment, the indication of ‘full configuration’ or ‘no full configuration’ may be a Full Configuration Indicator Information Element (IE) that is included by the target eNB in the Handover Request Acknowledge message to indicate whether the target eNB will handle forwarded downlink data according to the target eNB procedures for full configuration handover.

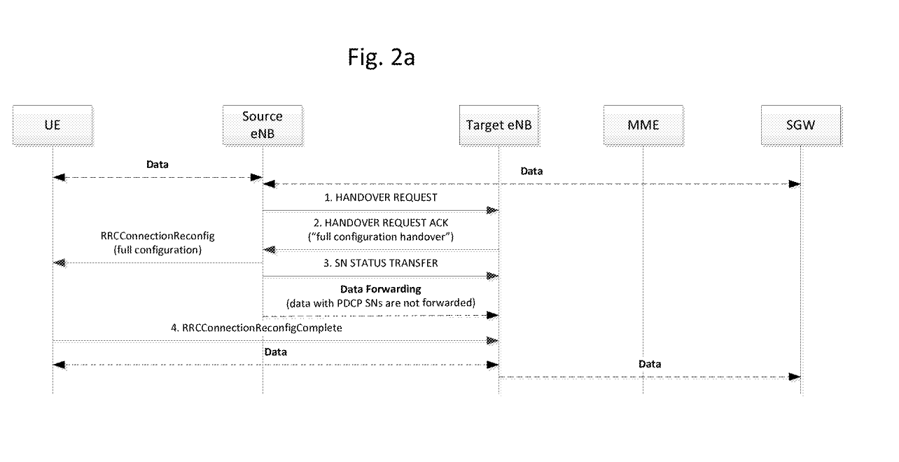

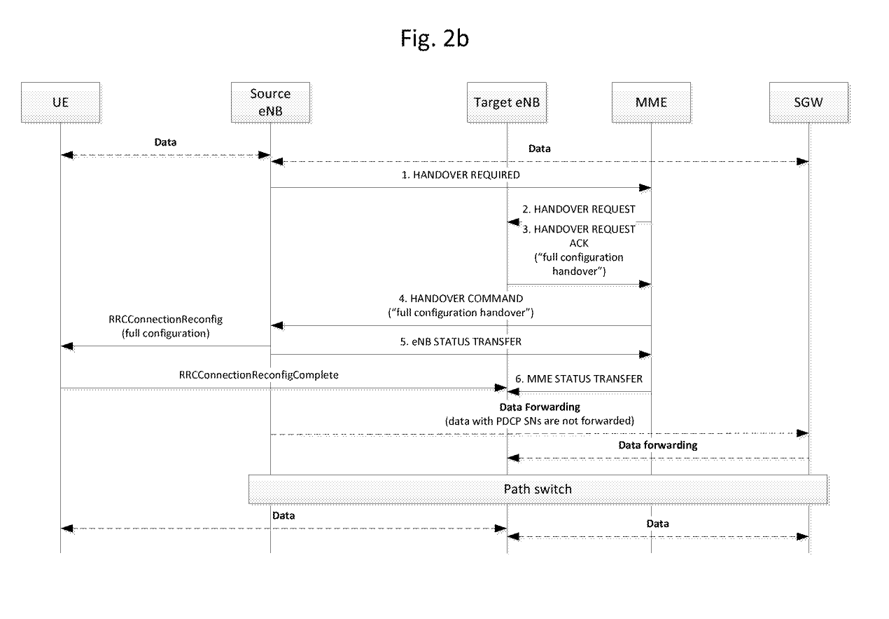

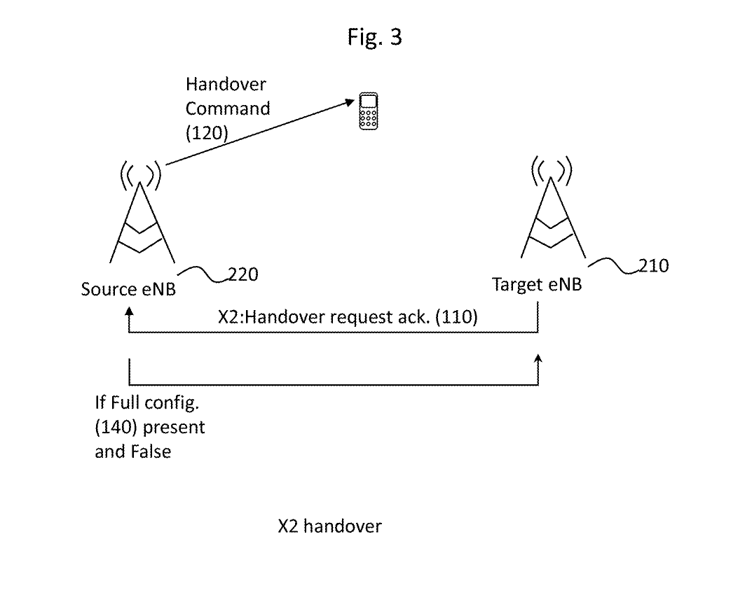

FIG. 2a illustrates an example signaling diagram depicting the signaling exchange, for instance, for X2 handover where UE 225 is configured for 18-bit PDCP SN but target eNB 210 does not support 18-bit PDCP SN, according to one embodiment. Similarly, FIG. 3 illustrates an example of a system for carrying out an embodiment of the invention in the case of X2 handover. In the example of FIGS. 2a and 3, the target eNB 210 includes an indication 140, to the source eNB 220 in the Handover Request Acknowledge message 110, that full configuration handover is being used (since target eNB 210 does not fully “comprehend” the UE configuration provided in the Handover Request message). As a result, the source eNB 220 now knows that the target eNB 210 will discard G-PDUs with PDCP SNs, log errors, and generate Support Extension Headers Notification messages; therefore, the source eNB 220 does not forward data with PDCP SNs. In the example of FIG. 2a, a signaling message SN STATUS TRANSFER is transmitted by the source eNB to the target eNB. By the current X2 application protocol (X2AP) specification in 3GPP TS 36.423, “The target eNB using Full Configuration for this handover as per TS 36.300 [15] shall ignore the information received in this message”. Thus, in one embodiment, when the source eNB knows that full configuration handover is being used at the target eNB, the source eNB refrains from transmitting SN STATUS TRANSFER to the target eNB.

In certain embodiments, the indication of whether ‘full configuration’ or ‘no full configuration’ is used may be included twice in separate parts of the Handover Request Acknowledge message 110, for example, once in a transparent container 130 destined for the UE associated with the handover and once in a non-transparent container 140 destined for the source eNB associated with the handover.

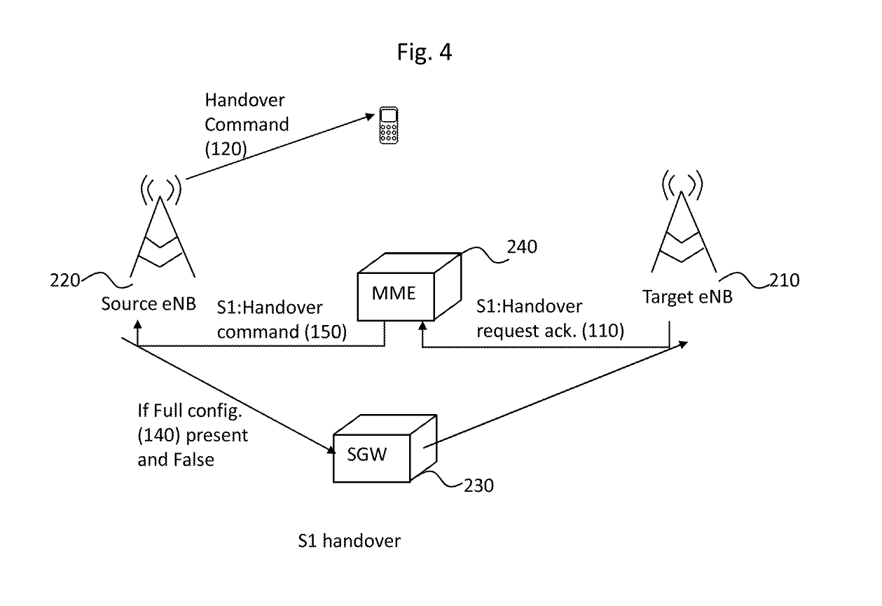

FIG. 2b illustrates an example signaling diagram depicting the signaling exchange for S1 handover, according to an embodiment. Similarly, FIG. 4 illustrates an example of a system for carrying out an embodiment of the invention in case of S1 handover. In the examples of FIGS. 2b and 4, the indication 140 may be included in a Handover Request Acknowledge message 110 sent from the target eNB 210 to the MME 240, and then forwarded in a Handover Command message 150 sent from the MME 240 to the source eNB 220.

According to an embodiment, data forwarding of PDCP SDUs with PDCP SN from a Rel-13-compliant source eNB (which understands this new indication) should only happen when the target eNB indicates ‘no full configuration’. Otherwise, the target eNB is either an earlier release eNB that does not support the indication (in which case full configuration may be assumed) or a Rel-13-compliant eNB using full configuration (which is indicated). In an embodiment, this new data forwarding rule may be applied if 18 bits PDCP SN has been configured to be used in source eNB.

In one embodiment, data forwarding of PDCP SDUs with PDCP SN from a Rel-13-compliant source eNB to an earlier release eNB (e.g., Rel-12 eNB) should only happen if the source eNB has (re)configured the UE to use only earlier release features (e.g., Rel-12 and earlier features), in which case the target eNB most probably will not use full configuration.

As a result of embodiments of the invention, GTP-U errors and Supported Extension Header Notification messages will be avoided when 18 bits PDCP SN is being used by a source eNB and the target eNB does not support it. Also, unnecessary PDCP SDU forwarding will be avoided in handover requiring full configuration, i.e., the source eNB would not forward PDCP SDUs with PDCP SN since they would be discarded by the target eNB.

In an embodiment, the new indication of whether full configuration is used or not used may be carried in a container that is transparent to the MME in S1 Application Protocol (S1AP) signaling. For example, in an embodiment, the handover request acknowledgement message may have a “second transparent container” containing the indication of whether full configuration is used. In this case, the indication of full configuration would become transparent to the MME. Therefore, embodiments do not have any impact on the MME and S1AP signaling protocol specification. Alternatively, in another embodiment, the indication of whether full configuration is used may be carried non-transparently with respect to the MME, where the MME forwards the full configuration indication non-transparently. Other solutions that would need to involve the SGW are not needed when embodiments of the invention are implemented.

Embodiments of the invention are not only limited to SN lengths not mutually supported by a source and target eNB. The proposed solution is also applicable for other cases causing discarding of PDCP PDUs when full configuration is triggered by target eNB. For example, in case the PDCP header format is otherwise unsupported by target eNB, full configuration would be required. In other words, embodiments of the invention are also applicable to those cases.

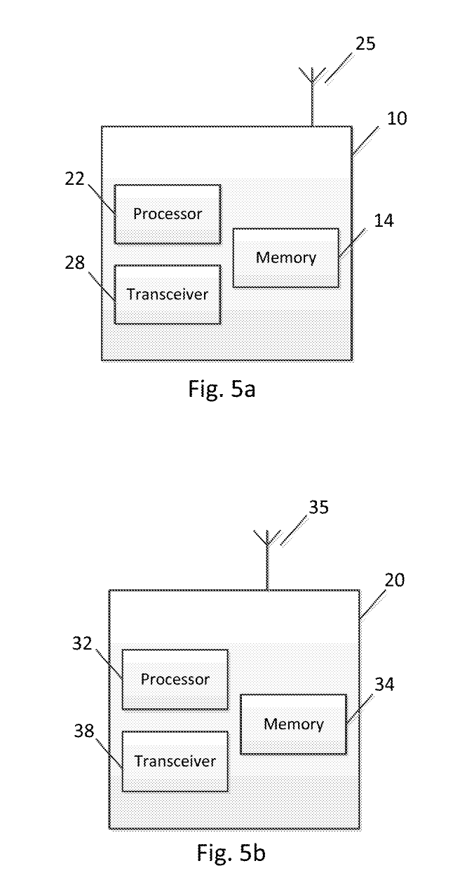

FIG. 5a illustrates an example of an apparatus 10 according to an embodiment. In an embodiment, apparatus 10 may be a node, host, or server in a communications network or serving such a network. For example, in certain embodiments, apparatus 10 may be a network access node or network entity for a radio access network, such as LTE or LTE-A. Thus, in certain embodiments, apparatus 10 may be a base station or eNB. However, in other embodiments, apparatus 10 may be other components within a radio access network. It should be noted that one of ordinary skill in the art would understand that apparatus 10 may include components or features not shown in FIG. 5a.

As illustrated in FIG. 5a, apparatus 10 includes a processor 22 for processing information and executing instructions or operations. Processor 22 may be any type of general or specific purpose processor. While a single processor 22 is shown in FIG. 5a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to an embodiment, apparatus 10 may be a network node or network entity, such as a base station or eNB, for example. In one embodiment, apparatus 10 may be a target eNB, such as target eNB 210 illustrated in FIGS. 2-4 discussed above. According to certain embodiments, apparatus 10 may be controlled by memory 14 and processor 22 to receive a handover request from a source eNB. Apparatus 10 may then be controlled by memory 14 and processor 22 to transmit a handover request acknowledgement that includes an indication of whether full configuration is used or not. In one embodiment, when the handover is X2 handover, apparatus 10 may be controlled by memory 14 and processor 22 to transmit the handover request acknowledgement including the indication of whether full configuration is used or not directly to the source eNB. In another embodiment, when the handover is S1 handover, apparatus 10 may be controlled by memory 14 and processor 22 to transmit the handover request acknowledgement including the indication of whether full configuration is used or not to a MME, and the MME then sends the indication to the source eNB in a handover command message.

In certain embodiments, the indication of whether full configuration is used may be included twice in separate parts of the handover request acknowledgement message. For instance, the indication may be included once in a transparent container destined for the UE associated with the handover and once in a non-transparent container destined for the source eNB associated with the handover.

According to one embodiment, the indication may inform the source eNB of whether apparatus 10 will handle forwarded downlink data according to the target eNB procedures for full configuration handover. In an embodiment, the indication included in the handover request acknowledgement or the handover command message may be a Full Configuration Indicator information element (IE) or a No Full Configuration Indicator information element (IE). It should be noted that the information elements may have different names. For example, instead of a Full Configuration Indicator, a Discard SDUs Indicator could be used, and instead of No Full Configuration Indicator, a Forward SDUs Indicator could be used.

According to an embodiment, the source eNB skips forwarding of (or discards) data (e.g., PDCP SDUs with PDCP SNs) when the indication indicates that full configuration is used. In one embodiment, the source eNB forwards data (e.g., PDCP SDUs with PDCP SNs) when the indication indicates that full configuration is not used.

FIG. 5b illustrates an example of an apparatus 20 according to another embodiment. In an embodiment, apparatus 20 may be a node, host, or server in a communications network or serving such a network. For example, in certain embodiments, apparatus 20 may be a network access node or network entity for a radio access network, such as LTE or LTE-A. Thus, in certain embodiments, apparatus 20 may be a base station or eNB. However, in other embodiments, apparatus 20 may be other components within a radio access network. It should be noted that one of ordinary skill in the art would understand that apparatus 20 may include components or features not explicitly shown in FIG. 5b.

As illustrated in FIG. 5b, apparatus 20 includes a processor 32 for processing information and executing instructions or operations. Processor 32 may be any type of general or specific purpose processor. While a single processor 32 is shown in FIG. 5b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a network node or network entity, such as a base station or eNB, for example. In one embodiment, apparatus 20 may be a source eNB, such as source eNB 220 illustrated in FIGS. 2-4 discussed above. According to an embodiment, apparatus 20 may be controlled by memory 34 and processor 32 to transmit a handover request to a target eNB. In certain embodiments, apparatus 20 may then be controlled by memory 34 and processor 32 to receive a message including an indication of whether full configuration is used or not. In one embodiment, when the handover is X2 handover, the message may be a handover request acknowledgement message received from the target eNB. In another embodiment, when the handover is S1 handover, the message may be a handover command message received from a MME. In certain embodiments, the indication of whether full configuration is used may be included twice in separate parts of the handover request acknowledgement message, such as once in a transparent container destined for the UE associated with the handover and once in a non-transparent container destined for the source eNB associated with the handover.

For example, in one embodiment, the indication may inform the apparatus 20 of whether the target eNB will handle forwarded downlink data according to the target eNB procedures for full configuration handover. In an embodiment, the indication received in the handover request acknowledgement or the handover command message may be a Full Configuration Indicator information element (IE).

According to an embodiment, apparatus 20 may be controlled by memory 34 and processor 32 to skip forwarding of (or to discard) data (e.g., PDCP SDUs with PDCP SNs) when the indication indicates that full configuration is used. In one embodiment, apparatus 20 may be controlled by memory 34 and processor 32 to forward data (e.g., PDCP SDUs with PDCP SNs) when the indication indicates that full configuration is not used.

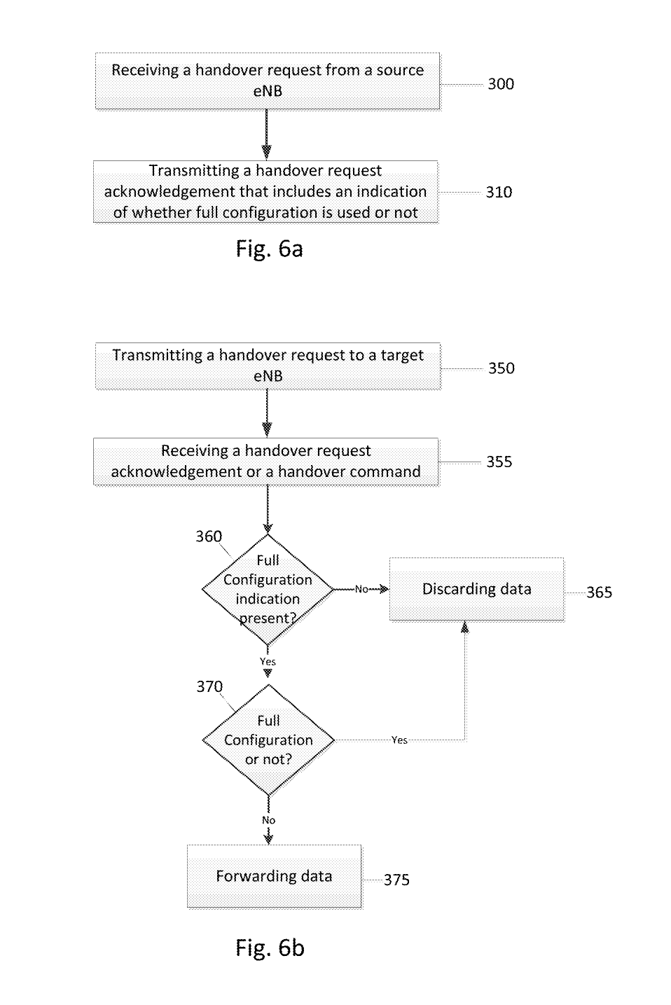

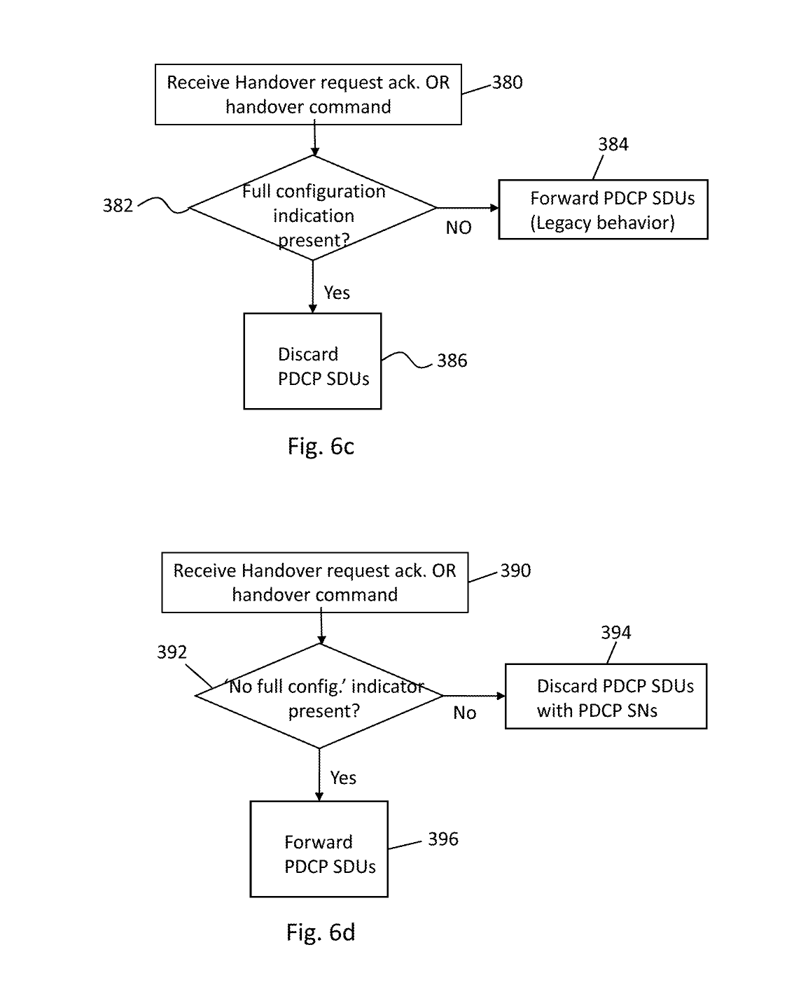

FIG. 6a illustrates an example flow diagram of a method, according to one embodiment. The method of FIG. 6a may be performed by a network node or entity, such as an eNB. For example, in an embodiment, the method may be performed by a target eNB. The method may include, at 300, receiving a handover request from a source eNB. The method may also include, at 310, transmitting a handover request acknowledgement that includes an indication of whether full configuration is used or not. In one embodiment, when the handover is X2 handover, the transmitting further includes transmitting the handover request acknowledgement including the indication of whether full configuration is used or not directly to the source eNB. In another embodiment, when the handover is S1 handover, the transmitting further includes transmitting the handover request acknowledgement including the indication of whether full configuration is used or not to a MME, and the MME then sends the indication to the source eNB in a handover command message.

For example, the indication may inform the source eNB of whether the target eNB will handle forwarded downlink data according to the target eNB procedures for full configuration handover. In an embodiment, the transmitting of the handover request acknowledgement comprises transmitting a Full Configuration Indicator information element (IE) in the handover request acknowledgement or the handover command message.

According to an embodiment, the source eNB skips forwarding of (or discards) data (e.g., PDCP SDUs with PDCP SNs) when the indication indicates that full configuration is used. In one embodiment, the source eNB forwards data (e.g., PDCP SDUs with PDCP SNs) when the indication indicates that full configuration is not used.

FIG. 6b illustrates an example flow diagram of a method, according to another embodiment. The method of FIG. 6b may be performed by a network node or entity, such as an eNB. For example, in an embodiment, the method may be performed by a source eNB. The method may include, at 350, transmitting a handover request to a target eNB. The method may then include, at 355, receiving a message, such as a handover request acknowledgement or a handover command. At 360, the method may include determining whether the message includes an indication of whether full configuration is used or not. For example, in one embodiment, the indication may inform the source eNB of whether the target eNB will handle forwarded downlink data according to the target eNB procedures for full configuration handover. If the message does not include such an indication, then the method may include, at 365, discarding data (e.g., PDCP SDUs with PDCP SNs). If the message does include an indication of whether full configuration is used or not, the method may include, at 370, checking whether the indication indicates that full configuration is used. When the indication indicates that full configuration is not used, the method may include, at 375, forwarding data (e.g., PDCP SDUs with PDCP SNs). When full configuration is used, the method may include, at 365, the discarding of data (e.g., PDCP SDUs with PDCP SNs).

In one embodiment, when the handover is X2 handover, the message may be a handover request acknowledgement message received from the target eNB. In another embodiment, when the handover is S1 handover, the message may be a handover command message received from a MME. In an embodiment, the indication received in the handover request acknowledgement or the handover command message may be a Full Configuration Indicator information element (IE).

It is noted that, in one embodiment, the process of FIG. 6b may assume that inclusion (in handover request acknowledgement or handover command messages) of the indication 140 of whether full configuration is used is mandatory for Rel-13 and newer eNBs. Thus, if the indication 140 is not present (e.g., due to old eNB that does not support it), the source eNB knows that the target eNB is of older release and most probably has sent full configuration 130 in the transparent container and, therefore, the source eNB does not forward data (e.g., PDCP SDUs).

FIG. 6c illustrates an example flow diagram of a method, according to another embodiment. The method of FIG. 6c may be performed by a network node or entity, such as an eNB. For example, in an embodiment, the method may be performed by a source eNB. The method may include, at 380, receiving a message, such as a handover request acknowledgement or a handover command. At 382, the method may include determining whether the message includes an indication of whether full configuration is used. In this embodiment, the indication is only present when full configuration is used. Thus, if the indication is not present in the message, then legacy behavior is assumed and the method includes, at 384, forwarding data (e.g., PDCP SDUs). In this embodiment, if the indication is present, then the method may include, at 386, discarding the data (e.g., PDCP SDUs). In one embodiment, an alternate name for the indication may be ‘Discard PDCP SDUs with PDCP SNs’ indicator.

FIG. 6d illustrates an example flow diagram of a method, according to yet another embodiment. The method of FIG. 6d may be performed by a network node or entity, such as an eNB. For example, in an embodiment, the method may be performed by a source eNB. The method may include, at 390, receiving a message, such as a handover request acknowledgement or a handover command. At 392, the method may include determining whether the message includes an indication of no full configuration. In this embodiment, the indication of no full configuration is only present when full configuration is not used. Thus, if the indication of no full configuration is missing, then it is assumed that full configuration is used and the method includes, at 394, discarding data (e.g., PDCP SDUs with PDCP SNs). If the indication of no full configuration is present, then the method may include, at 396, forwarding the data (e.g., PDCP SDUs with PDCP SNs). Accordingly, with this embodiment, the data (e.g., PDCP SDUs with PDCP SNs) is only forwarded when the indication of no full configuration is present. In this example embodiment, an alternative name for the indication may be ‘Forward PDCP SDUs’ indicator.

The embodiment illustrated in FIG. 6d may be beneficial if it is assumed that all new eNBs include the indicator when no full configuration is needed, because then data forwarding only happens from a Rel-13 or newer eNB if this indicator is present. Older (i.e., prior to Rel-13) eNBs never include this indicator and thus a Rel-13 or newer eNB never forwards data (e.g., PDCP SDUs with PDCP SNs) to older eNBs.

In view of the above, embodiments of the invention provide several technical improvements and/or advantages. For example, some of the technical improvements and/or advantages include, but are not limited to, avoiding GTP-U errors and Supported Extension Header Notification messages when 18 bits PDCP SN is being used by source eNB and target eNB does not support it. In addition, unnecessary PDCP SDU forwarding will be avoided in handover requiring full configuration, i.e., source eNB would not forward PDCP SDUs with PDCP SN since they would be discarded by the target eNB.

In some embodiments, the functionality of any of the methods, processes, or flow charts described herein may be implemented by software and/or computer program code or portions of it stored in memory or other computer readable or tangible media, and executed by a processor. In some embodiments, the apparatus may be, included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One embodiment may be directed to an apparatus including at least one processor and at least one memory including computer program code. The at least one memory and the computer program code are configured, with the at least one processor, to cause the apparatus at least to transmit a handover request to a target eNB and to receive a message, such as a handover request acknowledgement message or a handover command message. The apparatus may be further caused to determine whether the message includes an indication of whether full configuration is used or not. If the message does not include such an indication, then the apparatus may be controlled to discard data (e.g., PDCP SDUs with PDCP SNs). If the message does include an indication of whether full configuration is used or not, the apparatus may be caused to check whether the indication indicates that full configuration is used. When the indication indicates that full configuration is not used, the apparatus may be caused to forward data with PDCP SNs. When full configuration is used, the apparatus may be caused to discard data with PDCP SNs.

Another embodiment is directed to a method including transmitting a handover request to a target eNB. The method may then include receiving a message, such as a handover request acknowledgement or a handover command. The method may also include determining whether the message includes an indication of whether full configuration is used or not. If the message does not include the indication, then the method may include discarding data (e.g., PDCP SDUs with PDCP SNs). If the message does include an indication of whether full configuration is used or not, the method may include checking whether the indication indicates that full configuration is used. When the indication indicates that full configuration is not used, the method may include forwarding data (e.g., PDCP SDUs with PDCP SNs). When full configuration is used, the method may include the discarding of data (e.g., PDCP SDUs with PDCP SNs).

Another embodiment is directed to an apparatus comprising transmitting means for transmitting a handover request to a target eNB. The apparatus may also include receiving means for receiving a message, such as a handover request acknowledgement or a handover command. The apparatus may also include determining means for determining whether the message includes an indication of whether full configuration is used or not. If the message does not include the indication, then the apparatus may include discarding means for discarding data (e.g., PDCP SDUs with PDCP SNs). If the message does include an indication of whether full configuration is used or not, the apparatus may include checking means for checking whether the indication indicates that full configuration is used. When the indication indicates that full configuration is not used, the apparatus may include forwarding means for forwarding data (e.g., PDCP SDUs with PDCP SNs). When full configuration is used, the apparatus may include discarding means for discarding of data (e.g., PDCP SDUs with PDCP SNs).

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. An apparatus comprising at least one processor and at least one memory including computer program code, the at least one memory and the computer program code configured, with the at least one processor, to cause the apparatus at least to:
receive a handover request acknowledgement message or a handover command message;
determine whether the received message includes an indication of whether full configuration is used by a target base station for a user equipment associated with the handover;
if the received message includes the indication, determine whether the indication indicates that full configuration is used; and
if the indication indicates that full configuration is used, discard data destined for the user equipment; otherwise if the indication indicates that full configuration is not used, forward the data towards the target base station.

2. The apparatus of claim 1, wherein if the received message is determined not to include the indication, discard data destined for the user equipment.

3. The apparatus of claim 1, wherein the data comprises at least one of a packet data convergence protocol service data unit comprising a packet data convergence protocol sequence number and a sequence number status transfer.

4. The apparatus of claim 1, wherein the received message comprises the indication of whether full configuration is used in a container non-transparent to the apparatus.

5. The apparatus of claim 4, wherein the received message comprises a second indication of whether full configuration is used in a container transparent to the apparatus.

6. The apparatus of claim 4, wherein the container is transparent to a mobility management entity from which the message is received.

7. The apparatus of claim 1, wherein the discarding is performed when the apparatus is configured for 18-bit packet data convergence protocol sequence numbers.

8. The apparatus of claim 1, the at least one memory and the computer program code configured, with the at least one processor, to further cause the apparatus at least to: determine a release version in dependence of the determination whether the received message includes the indication of whether full configuration is used.

9. The apparatus of claim 1, wherein the apparatus comprises a source base station.

10. An apparatus comprising at least one processor and at least one memory including computer program code, the at least one memory and the computer program code configured, with the at least one processor, to cause the apparatus at least to:
receive a handover request message requesting handover for a user equipment;
determine whether the user equipment requires full configuration; and
transmit towards a serving base station associated with the user equipment a handover request acknowledgement comprising a container comprising a first full configuration indication in accordance with the determination, wherein the container non-transparent to the serving base station.

11. The apparatus according to claim 10, wherein the handover request acknowledgement further comprising a second container comprising a second full configuration indication in accordance with the determination, wherein the second container transparent to the serving base station.

12. The apparatus according to claim 10, wherein the first full configuration indication is included in the handover request acknowledgement when the user equipment does not require full configuration and is not included when the user equipment requires full configuration.

13. A method comprising:
receiving a handover request acknowledgement message or a handover command message;
determining whether the received message includes an indication of whether full configuration is used by a target base station for a user equipment associated with the handover;
if the received message includes the indication, determining whether the indication indicates that full configuration is used; and
if the indication indicates that full configuration is used, discarding data destined for the user equipment; otherwise if the indication indicates that full configuration is not used, forwarding the data towards the target base station.

14. The method of claim 13, wherein if the received message is determined not to include the indication, discarding data destined for the user equipment.

15. The method of claim 13, wherein the data comprises at least one of a packet data convergence protocol service data unit comprising a packet data convergence protocol sequence number and a sequence number status transfer.

16. The method of claim 13, wherein the received message comprises the indication of whether full configuration is used in a container non-transparent to an apparatus receiving the message.

17. The method of claim 16, wherein the received message comprises a second indication of whether full configuration is used in a container transparent to the apparatus.

18. The method of claim 16, wherein the container is transparent to a mobility management entity from which the message is received.

19. The method of claim 13, wherein the discarding is performed when an apparatus receiving the message is configured for 18-bit packet data convergence protocol sequence numbers.

20. The method of claim 13, further comprising: determining a release version in dependence of the determination whether the received message includes the indication of whether full configuration is used.
